(19) United States
(12) Patent Application Publication
(10) Pub. No.: US 2007/0289997 A1
(43) Pub. Date: Dec. 20, 2007

(54) Soap and Grit Dispenser

(76) Inventors: Richard Paul Lewis, Marietta, GA (US); Paul Francis Tramontina, Harleysville, PA (US); Victor Scott Shoaf, Alpharetta, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/611,242

(22) Filed: Dec. 15, 2006

Related U.S. Application Data
(60) Provisional application No. 60/805,000, filed on Jun. 16, 2006.

(51) Int. Cl. B67D 5/52; A47K 5/06

(52) U.S. Cl. 222/137

(57) ABSTRACT

A dispenser which may include a housing holding a soap cartridge for foamed soap and a grit solution cartridge. The housing includes a push button and an exit port. The dispenser also includes a pair of pumps in liquid communication with the soap and grit solution. In addition, the dispenser may alternatively comprise a cartridge having two chambers: one chamber for soap and another for a grit solution. In this instance a pump is positioned in each chamber, and a portion of the pump is positioned adjacent a nozzle having a push button. When the push button is pushed by a user, foamed soap and grit solution are dispensed separately but simultaneously such that the foamed soap surrounds the grit solution as both as deposited simultaneously into a user's palm.

### CROSS-REFERENCE TO RELATED APPLICATIONS

The present invention claims priority to U.S. Ser. No. 60/805,000, filed Jun. 16, 2006, entitled “SOAP AND GRIT DISPENSER”, by Richard Paul Lewis, et al., Attorney Docket No. 64123227US01.

### BACKGROUND OF THE INVENTION

This invention relates to a dispenser adapted to hold a cartridge containing soap, such as a liquid soap, and preferably a soap which may be foamed for dispensing. In addition, the dispenser is adapted to hold a cartridge containing a gritty, abrasive material (“grit”) which is desirably, but not by way of limitation, suspended in a liquid (“grit solution”). The dispenser is adapted to dispense both the soap and grit solution.

Hand washing in industrial situations often results in incompletely cleaned hands, especially when attempting to wash certain substances, such as industrial grease, from one's hands. Soaps incorporating grit are frequently used. However, obtaining sufficient grit or abrasive material to sufficiently clean one's hands from bar soap is often difficult.

Therefore, is would be desirable to provide a dispenser having two cartridges therein. One cartridge desirably provides a liquid soap, and desirably, a liquid soap which may be foamed when dispensed into an individual's hand. The other cartridge provides grit in a liquid solution. The soap desirably dispenses through a dispensing opening formed in the cartridge. Similarly, the grit solution desirably dispenses through an opening provided in its cartridge. Each of the dispensing openings are desirably adjacent or next to each other, such that when a dispensing button is pushed or actuated, both cartridges are activated. Liquid soap, which may desirably, but not by way of limitation, be foamed is dispensed through the soap dispensing opening and simultaneously grit solution is dispensed through the grit solution dispensing opening. Therefore, a small amount or mound of soap and a small amount or mound of grit solution are desirably simultaneously dispensed and disposed adjacent each other or together on a palm of a user's hand for hand washing.

### DEFINITIONS

As used herein, the term “soap” refers to any soap which may be used for cleaning a human being's hands.

As used herein, the term “foamed soap” refers to any soap which may be foamed which may be used for cleaning a human being's hands.

As used herein, the term “grit” refers to any natural and/or synthetic material(s) which may be abrasive and used for abrasion during hand washing.

As used herein, the term “grit solution” refers to grit (as described herein) suspended in a liquid such as, but not by way of limitation, water, oil and/or alcohol.

As used herein, the term “exit port” or “dispensing opening” is the opening in a dispenser for the passage of one or more solutions, such as a soap solution or a grit solution, therethrough.

As used herein, the term “fasteners” means devices that fasten, join, connect, secure, hold, or clamp components together. Fasteners include, but are not limited to, screws, nuts and bolts, rivets, snap-fits, tacks, nails, loop fasteners, and interlocking male/female connectors, such as fishhook connectors, a fish hook connector includes a male portion with a protrusion on its circumference. Inserting the male portion into the female portion substantially permanently locks the two portions together.

As used herein, the term “couple” includes, but is not limited to, joining, connecting, fastening, linking, or associating two things integrally or interstitially together.

As used herein, the term “configure”, “configured” and/or “configuration” means to design, arrange, set up, or shape with a view to specific applications or uses. For example: a military vehicle that was configured for rough terrain; configured the computer by setting the system's parameters.

As used herein, the terms “orientation” or “position” used interchangeably herein refer to the spatial property of a place where or way in which something is situated; for example, “the position of the hands on the clock.”

As used herein, the term “substantially” refers to something which is done to a great extent or degree; a significant or great amount; for example, as used herein “substantially” as applied to “substantially” covered means that a thing is at least 90% covered.

As used herein, the term “about” refers to an amount that is plus or minus 10 percent of a stated or implied range.

As used herein, the term “alignment” refers to the spatial property possessed by an arrangement or position of things in a straight line or in parallel lines.

As used herein, the term “side-by-side alignment” refers to the soap being positioned adjacent and desirably next to the grit solution; this alignment may include the soap being positioned forward and the grit solution being positioned rearward, or vice versa, in a generally axial alignment relative to a user's arm, the soap and grit solution may be positioned adjacent or next to each other in a generally transverse alignment relative to a user's arm, or the soap and grit solution may be positioned in an oblique alignment adjacent or next to each other relative to a user's arm.

These terms may be defined with additional language in the remaining portions of the specification.

### SUMMARY OF THE INVENTION

In response to the difficulties and problems discussed herein, a dispenser for dispensing soap and grit is provided. The dispenser comprises a housing formed to include an internal compartment. The housing also includes a push button and at least one exit port. The internal compartment is configured to hold a soap cartridge and a grit solution cartridge. The dispenser also comprises a pair of pumps. One pump positioned in liquid communication with the soap cartridge and another pump positioned in liquid communication with the grit solution cartridge. Each pump has a dispensing opening. The soap cartridge and the grit solution cartridge are positioned in internal compartment of the housing, and a portion of each pump is positioned adjacent to the push button such that when the push button is pushed by a user, both pumps are simultaneously actuated such that soap and grit solution are dispensed simultaneously through each respective dispensing opening and through the exit port of the housing such that both foamed soap and grit solution are dispensed simultaneously onto a user's hand.

In another aspect of the invention, a dispensing assembly for dispensing soap and grit is provided. The dispensing assembly comprises a dispenser including a housing which is formed to include an internal compartment. The housing includes a push button and an exit port. The dispensing assembly also includes a soap cartridge and a grit solution cartridge. The dispensing assembly further includes a pair or pumps. One pump is positioned in liquid communication with the soap cartridge and another pump is positioned in liquid communication with the grit solution cartridge. Each pump has a dispensing opening. The soap cartridge and the grit solution cartridge are positioned in the internal compartment of the housing. A portion of each pump is positioned adjacent to the push button such that when the push button is pushed by a user, both pumps are simultaneously actuated such that soap and grit solution are dispensed simultaneously through each respective dispensing opening and through the exit port of the housing such that both foamed soap and grit solution are dispensed simultaneously onto a user's hand.

In yet another aspect of the invention, a dispensing assembly for dispensing soap and grit are provided. The dispensing assembly comprises at least one cartridge which includes a soap chamber and a grit solution chamber. The cartridge includes a pair or pumps. One pump is positioned in liquid communication with the soap chamber and another pump is positioned in liquid communication with the grit solution chamber. Each pump has a dispensing opening. The dispensing assembly also includes a dispensing nozzle which includes a push button. The dispensing nozzle includes two dispensing openings. One of the openings is in liquid communication with the soap and one of the openings is in liquid communication with the grit solution. A portion of each pump is positioned adjacent to the push button such that when the push button is pushed by a user, both pumps are simultaneously actuated such that soap and grit solution are dispensed simultaneously through each respective dispensing opening such that both foamed soap and grit solution are dispensed onto a user's hand simultaneously.

### BRIEF DESCRIPTION OF THE DRAWINGS

FIG. 1 is a perspective view of an above-the-counter dispenser and system to dispense liquid soap and grit solution from separate cartridges simultaneously; showing the dispenser, the soap and grit solution cartridges shown external to the dispenser for illustrative purposes only, a sink with water spigot and knobs, and a user's hands, the soap cartridge including a soap dispensing opening and the grit solution cartridge including a grit solution dispensing opening, a push button on the dispenser to actuate both cartridges desirably simultaneously so that a user obtains a mound of soap and a mound of grit solution adjacent each other on a palm of a user's hand;

FIG. 2 is a front plan view of the dispenser of FIG. 1, showing a base holding soap and grit solution cartridges of a different configuration than those shown in FIG. 1, but showing a pump positioned in each cartridge, a portion of the pump configured to be positioned adjacent the push button on the dispenser so that the output from each pump is directed to an exit port;

FIG. 3 is a perspective view of a dispenser which may be used as an above-the-counter dispenser or a below-the-counter dispenser, which provides a separate cylindrical cartridge for the soap and the grit solution; each cartridge including its own pump, the soap and grit solution being movable from its respective cartridge by each pump and through via a push button to a common dispensing nozzle or spigot;

FIG. 4 is a side view having a cut-away section of a below-the-counter soap and grit solution cartridge somewhat different than the one shown in FIG. 3, which provides a separate soap chamber and a separate grit solution chamber, each chamber having its own associated pump extending upward therefrom; and

FIG. 5 is a lower perspective view of the above-the-counter dispensing nozzle or spigot and its separate dispensing openings for the grit solution and the soap of FIG. 4.

### DETAILED DESCRIPTION

Reference will now be made in detail to one or more embodiments of the invention, examples of which are illustrated in the drawings. Each example and embodiment is provided by way of explanation of the invention, and is not meant as a limitation of the invention. For example, features illustrated or described as part of one embodiment may be used with another embodiment to yield still a further embodiment. It is intended that the invention include these and other modifications and variations as coming within the scope and spirit of the invention.

It is desirable to provide grit with industrial hand cleaners. Further, it is desirable to provide liquid soap as a foamed soap. There are difficulties, however, in providing grit in a foamed soap. The viscosity required to produce good foaming properties in soap is relatively low while the viscosity of the solution required to keep grit particles evenly suspended throughout the solution is relatively high. Formulating a liquid soap with viscosities low enough to produce a good foam allows the grit to separate and settle to the bottom of the liquid soap. In addition, the foaming pumps which use air along with the liquid soap to produce foamed soap also prevent the mixing of a foamed soap and grit. Small screens, generally, two or more, are used along with the liquid soap and air to causing foaming. The size of the openings in the screens are usually smaller than the size of the grit particles. Therefore, the grit particles become trapped in the screens and clog dispensing of soap as well as grit. In the present invention, this problem is alleviated by providing separate cartridges or chambers for dispensing liquid soap desirably as a foamed soap and a grit solution.

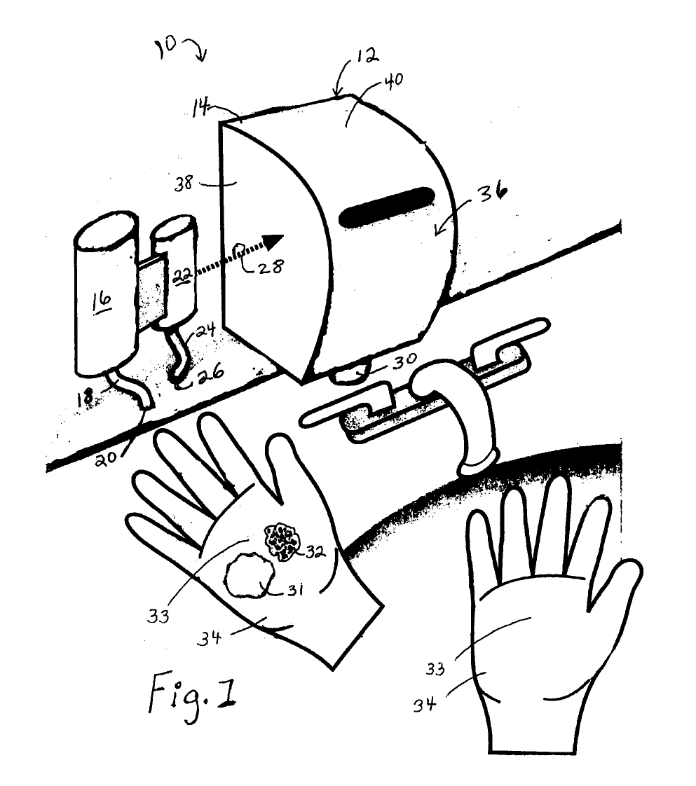

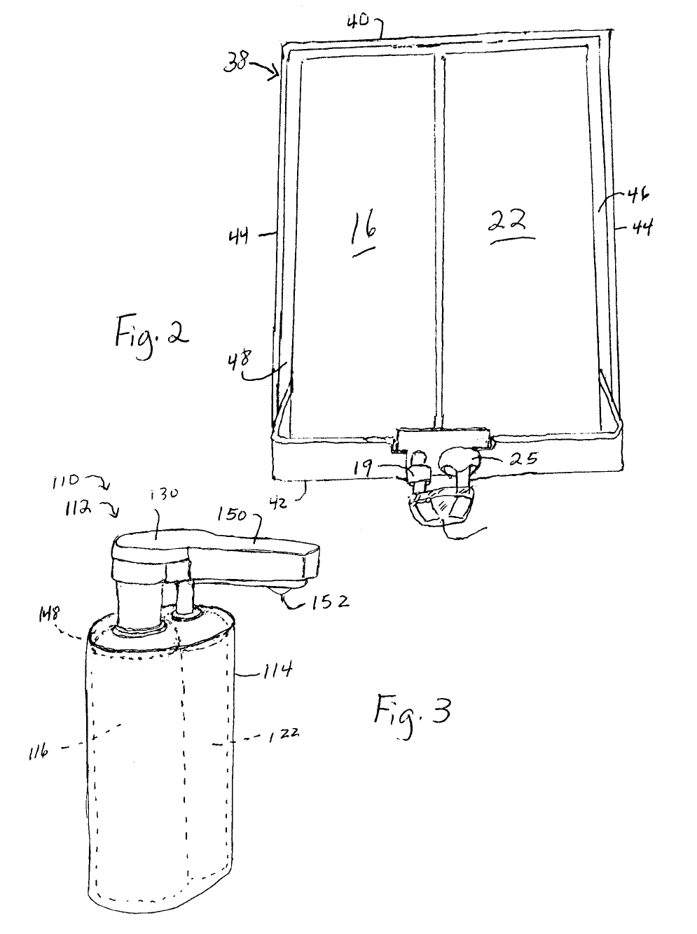

Referring now to FIGS. 1 and 2, the present invention provides a dispensing assembly 10. The dispensing assembly 10 of FIGS. 1 and 2 (FIG. 2 being a somewhat different cartridge configuration than FIG. 1) includes an above-counter dispenser 12 which dispenses generally but not by way of limitation, below the dispenser 12. The dispenser 12 includes a dispensing housing 14. The assembly 10 further includes a soap cartridge 16 which may include tubing 18 extending therefrom (or from a pump coupled thereto, as shown in FIG. 2) which provides a soap dispensing opening 20. A grit solution cartridge 22 is desirably positioned adjacent the soap cartridge 16. The grit cartridge 22 may also include tubing 24 extending therefrom (or from a pump coupled thereto, as shown in FIG. 2) which provides a grit solution dispensing opening 26 desirably adjacent the soap dispensing opening 20.

As indicated by arrow 28, both the soap cartridge 16 and the grit solution cartridge 22 are desirably positioned inside of the dispenser housing 14. The dispenser housing 14 desirably includes a push button 30 which actuates both cartridges 16, 22 such that both a small amount or mound of foamed soap 31 and a small amount or mound of grit solution 32 are deposited side-by-side or together (i.e., the foamed soap surrounds the grit solution as both are deposited) on a palm 33 of a user's hand 34.

The cartridges 16 and 22 may be formed from a plastic and/or metal. Desirably, the cartridges 16 and/or 22 are formed from a plastic. However, the cartridges 16 and/or 23 may be formed, for example, but not by way of limitation, from a plastic film, paperboard, and so forth. The dispenser housing 14 is desirably formed from plastic, metal, and so forth. The cartridges 16 and 22 are desirably, but not by way of limitation, formed to be detached and replaced when the cartridges 16 and 22 are empty. Alternative, each cartridge 16 and 22 may be refilled.

The dispenser housing 14 may desirably be formed to have a front cover 36 (FIG. 1) which is configured to move and/or separate at least partially away from a base 38. The base 38, as shown best in FIG. 2, may be formed to include at least a portion of an upper wall 40 and a lower wall 42. The base 38 may also include a pair of opposing side walls 44 which extend between and are coupled to at least a portion of an upper wall 40 and a lower wall 42. A back wall (not shown) desirably couples to the side walls 44 and the upper wall 40 and lower wall 42. When the front cover 36 is disposed over the base 38 in a dispensing position, they cooperate to provide an inner surface 46 which defines an internal compartment 48 configured to hold the soap cartridge 16 and the grit solution cartridge 22, as well as the soap pump 19, the grit solution pump 25, and associated apparatus, described below.

At least one exit port (not shown) may be provided in the housing 14. Desirably, but not by way of limitation, the exit port is provided in the front cover 36. Alternatively, the exit port is provided in a portion of the base 38. The soap dispensing opening 20 and the grit solution dispensing opening 26 may provide a portion of the exit port for dispensing both from the dispenser 12 (not shown).

The dispenser 12 is desirably mounted to a vertical surface, such as, for example, a wall, and is coupled thereto via fasteners, adhesives, mounting brackets, and so forth (not shown).

The soap and grit solution cartridges 16 and 22 may have an adaptable insert port (not shown). Such a port may be used so that the cartridges 16 and 22 may be placed in liquid communication (usually, but not by way of limitation, via tubing) with their respective soap and grit solution pumps 19 and 25, in order to move soap 31 and grit solution 32 from their respective cartridges and through their respective dispensing openings 20 and 26 to and through the exit port. Such a port may be a frictional port, a threaded port, and so forth.

Alternatively, however, it will be appreciated that the soap and grit solution cartridges 16 and 22 may each include its own respective integral pumps 19 and 25. In yet another alternative, the soap pump 19 and the grit solution pump 25 may be provided as a portion of the dispenser housing 14. The pumps 19 and 25 may be sized differently, or one pump may be configured to move more liquid than the other, so that one push of the push button 30 activates the pumps to provide different amounts of liquid from each cartridge 16 and 22.

The push button 30 is desirably provided in a position on the housing 14 which is readily accessible to a user. Desirably, but not by way of limitation, the push button 30 actuates each pump 19 and 25 simultaneously. Desirably, each pump 19 and 25 and its associated apparatus is positioned adjacent each cartridge 16 and 22. A portion 49 of the push button 30 is coupled to or positioned adjacent to a portion of each pump 19 and 25. When the button 30 is pushed by a user, desirably, each pump 19 and 25 is actuated and each pump 19 and 25 moves soap and grit solution 32 so that foamed soap 31 and grit solution are simultaneously dispensed from their respective cartridges 14, 22, through their respective dispensing openings 20, 26 and through the exit port (not shown) of the dispenser housing 14 and deposited in the palm 33 of a user's hand 34. Alternatively, the push button 30 may have a movable head (not shown) that permits a user to push one side of the button to receive foamed soap and another side of the button to receive the grit solution. If such a button is pushed in the center, it simultaneously dispenses both foamed soap and grit solution. In another alternative (not shown), separate buttons may be provided.

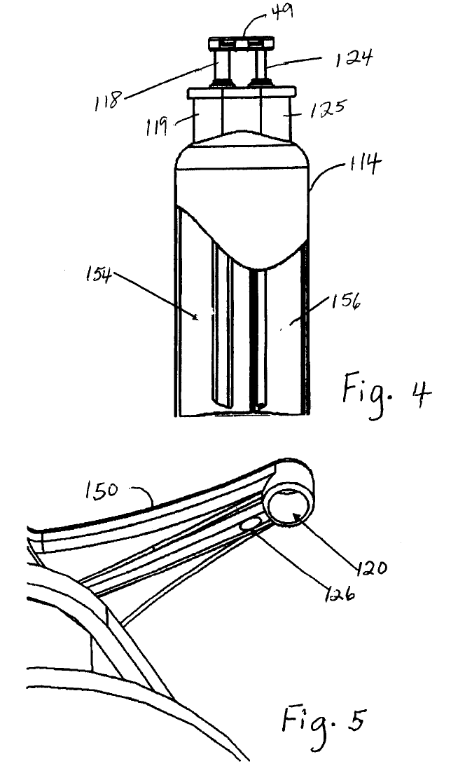

Referring now to FIGS. 3-5, the dispensing assembly 110 and the dispenser 112 are similar to those shown in FIGS. 1 and 2 and described in detail previously, except that dispensing assembly 110 and dispenser 112 may be provided, but not by way of limitation, as a below-the-counter dispenser having a dispensing nozzle or spigot 150 (FIGS. 3 and 5) which may be positioned above the counter which includes a push button 130 which couples to both the soap cartridge 116 and the grit solution cartridge 122 to permit the dispensing of the foamed soap 31 and grit solution 32, desirably simultaneously. In this embodiment, the soap and grit solution dispensing openings 120,126, as shown in FIG. 5, may be positioned in the dispensing nozzle or spigot 150. The dispensing openings 120, 126 may be positioned in a side-by-side alignment with the soap dispensing opening 120 positioned forward relative to the grit solution dispensing opening 126. The dispensing openings 120, 126 may be in any alignment, or may be combined within the dispensing nozzle or spigot 150 so that the foamed soap and grit are deposited through an exit port 152, as illustrated in FIG. 3.

The dispenser 112 includes a different type of housing 114. As shown in FIG. 3, the housing 114 may be configured to provide an internal compartment 148 sized to hold separate soap and grit solution cartridges 116 and 122. In this configuration, the cartridges 116 and 112 may be refillable, or, alternatively, may comprise a one-use non-refillable disposable cartridge. Turning to FIG. 4, however, the housing 114 itself may comprise one or more cartridges. That is, the cartridge or housing 114 may include a soap chamber 154 and a separate grit solution chamber 156, as illustrated by a partially cut-away section of FIG. 4.

Desirably, for the embodiments illustrated in FIGS. 3-5, a soap pump 119 extends from the soap chamber 54, and a separate grit solution pump 125 extends from the grit solution chamber 156. It will be understood that tubing, such as, for example, the tubing 118 and 124 shown in FIG. 1, will be utilized to provide liquid communication from the soap chamber 154 via the soap pump 119, and the grit solution chamber 156 via the grit solution pump 125, respectively, and through the dispensing openings 120, 126 for the soap 31 and the grit solution 32, respectively, at the dispensing nozzle or spigot 150, illustrated in FIG. 5. In this variation, the chambers 154, 156 of the housing 114 may be refillable. Alternatively, the housing 114 may be a one-use non-refillable housing, and may be disposed of. Other alternatives, such as, for example, the use of separate cartridges for soap and grit solution, without a housing, may also be utilized.

Dispensers for liquid soaps and lotions are known in the art, and any such dispenser which operates as shown and/or described herein may be utilized. Such soap dispensers are disclosed, for example, but not by way of limitation, in U.S. Pat. No. 4,573,612, U.S. Pat. No. 5,226,566, and U.S. Pat. Application Publication No. 2005/0284887 A1, all of which are incorporated by reference herein to the extend that they are consistent with the teachings of the present invention.

A foaming or non-foaming soap may be used. Desirably, however, a foaming soap is used. Such soaps and/or methods of dispensing soaps are disclosed, for example, but not by way of limitation, in U.S. Pat. No. 6,495,151, U.S. Pat. No. 6,211,139, U.S. Pat. No. 5,720,961, and U.S. Pat. No. 3,962,150, as well as U.S. Pat. Application Publication No. 2005/0137102 A1, U.S. Pat. Application Publication No. 2005/0049157 A1, and U.S. Pat. Application Publication No. 2005/0284887 A1, all of which are incorporated by reference herein to the extent that they are consistent with the teachings of the present invention. Any type of soap may be used so long as the soap operates as shown and/or described herein.

Any type of natural and/or synthetic abrasive material, such as granularized pumas, polyethylene particles, and so forth, may be used as grit, so long as it is safe for its intended use and it is dispensable, as shown and/or described herein. Similarly, the grit may be suspended in any liquid, such as, but not by way of limitation, water, oil, alcohol, and so forth, which is safe for the use intended and which permits the grit to be dispensed as shown and/or described herein.

Desirably, however, the grit solution includes a thickener, water, and grit. More desirably, the grit solution is about 89.5 percent deionized water, about 0.32 percent acrylic polymer, about 0.1 percent aminomethylpropanol, and about a 5 to 10 percent polyethylene grit (particles). Most desirably, however, the grit is about a 10 percent polyethylene grit. Polyethylene grit is about the texture and size of a fine-grained sand, and it is desirable because it floats rather than sinks, and therefore will not contribute to clogging pipes, and so forth.

The dispensing assembly, dispenser and/or cartridges, and any associated portions thereof, such as the pumps, button(s), and so forth, may comprise any configuration(s), and made from any material(s), so long as they operate as shown and/or described herein.

While it is desirable to dispense the foamed soap and grit solution together, it will be appreciated that the orientation of the receipt of such ingredients in a user's hand may be altered. That is, the foamed soap and grit my be deposited next to each other, in a side-by-side orientation, as shown in FIG. 1, Alternatively, however, the foamed soap and the grit solution may be deposited together, in one “lump” which combines both. That is, when the soap is discharged and desirably, but not by way of limitation, foamed and discharged from an exit port, it hides the grit solution within it as both flow through the exit port and both are deposited on a user's hand. Further, while it will be appreciated that a foamed soap is desirable, it will be understood that a liquid soap may be used as well.

While the present invention has been described in connection with certain preferred embodiments, it is to be understood that the subject matter encompassed by way of the present invention is not to be limited to those specific embodiments. On the contrary, it will be appreciated that some elements and/or articles may be used with other elements or articles. It is intended for the subject matter of the invention to include all alternatives, modifications and equivalents as can be included within the spirit and scope of the invention.

What is claimed is:

1. A dispenser for dispensing soap and grit, the dispenser comprising:
a housing formed to include an internal compartment, the housing including a push button and at least one exit port, the internal compartment configured to hold a soap cartridge and a grit solution cartridge;
a pair of pumps, one pump positioned in liquid communication with the soap cartridge and another pump positioned in liquid communication with the grit solution cartridge, each pump having a dispensing opening, the soap cartridge and the grit solution cartridge positioned in the internal compartment of the housing, a portion of each pump positioned adjacent to the push button such that when the push button is pushed by a user, both pumps are simultaneously actuated such that soap and grit solution are dispensed simultaneously through each respective dispensing opening and through the exit port of the housing such that both foamed soap and grit solution are dispensed simultaneously onto a user's hand.

2. The dispenser of claim 1, wherein each cartridge has a port configured to receive a portion of a pump.

3. The dispenser of claim 2, wherein each pump is carried by a cartridge.

4. The dispenser of claim 1, wherein each cartridge includes a pump.

5. The dispenser of claim 1, wherein the pump is carried by the housing.

6. The dispenser of claim 1, wherein the pump is coupled to the housing.

7. The dispenser of claim 1, wherein the grit solution comprises a thickener, water and grit.

8. The dispenser of claim 7, wherein the grit solution comprises about 89.5% deonized water.

9. The dispenser of claim 7, wherein the grit solutions comprises about 0.32% acrylic polymer.

10. The dispenser of claim 7, wherein the grit solution comprises about 0.1% aminomethylpropanol.

11. The dispenser of claim 7, wherein the grit solution comprises about 10% polyethylene grit.

12. The dispenser of claim 11, wherein the grit solution comprises between about 5% and about 10% polyethylene grit.

13. A dispensing assembly for dispensing soap and girt, the dispensing assembly comprising:
a dispenser including a housing which is formed to include an internal compartment, the housing including a push button and an exit port;
a soap cartridge;
a grit solution cartridge;
a pair or pumps, one pump positioned in liquid communication with the soap cartridge and another pump positioned in liquid communication with the grit solution cartridge, each pump having a dispensing opening, the soap cartridge and the grit solution cartridge positioned in the internal compartment of the housing, a portion of each pump is positioned adjacent to the push button such that when the push button is pushed by a user, both pumps are simultaneously actuated such that soap and grit solution are dispensed simultaneously through each respective dispensing opening and through the exit port of the housing such that both foamed soap and grit solution are dispensed simultaneously onto a user's hand.

14. The dispensing assembly of claim 13, wherein each cartridge has a port configured to receive a portion of a pump.

15. The dispensing assembly of claim 14, wherein each pump is carried by a cartridge.

16. The dispensing assembly of claim 13, wherein each cartridge includes a pump.

17. The dispensing assembly of claim 13, wherein the pump is carried by the housing.

18. The dispensing assembly of claim 13, wherein the pump is coupled to the housing.

19. The dispensing assembly of claim 13, wherein the grit solution comprises a thickener, water and grit.

20. The dispensing assembly of claim 19, wherein the grit solution comprises about 89.5% deonized water.

21. The dispensing assembly of claim 19, wherein the grit solutions comprises about 0.32% acrylic polymer.

22. The dispensing assembly of claim 19, wherein the grit solution comprises about 0.1% aminomethylpropanol.

23. The dispensing assembly of claim 19, wherein the grit solution comprises about 10% polyethylene grit.

24. The dispensing assembly of claim 23, wherein the grit solution comprises between about 5% and about 10% polyethylene grit.

25. A dispensing assembly for dispensing soap and grit, the dispenser assembly comprising:
at least one cartridge including a soap chamber and a grit solution chamber, the cartridge including a pair or pumps, one pump positioned in liquid communication with the soap chamber and another pump positioned in liquid communication with the grit solution chamber, each pump having a dispensing opening: and
a dispensing nozzle including a push button, the dispensing nozzle including two dispensing openings, one of the openings in liquid communication with the soap and one of the openings in liquid communication with the grit solution, a portion of each pump positioned adjacent to the push button such that when the push button is pushed by a user, both pumps are simultaneously actuated such that soap and grit solution are dispensed simultaneously through each respective dispensing opening such that both foamed soap and grit solution are dispensed onto a user's hand simultaneously.

26. The dispensing assembly of claim 25, wherein each cartridge has a port configured to receive a portion of a pump.

27. The dispensing assembly of claim 26, wherein the pump is coupled to the cartridge via the port.

27. The dispensing assembly of claim 25, wherein each cartridge includes a pump.

28. The dispensing assembly of claim 25, wherein the grit solution comprises a thickener, water and grit.

29. The dispensing assembly of claim 28, wherein the grit solution comprises about 89.5% deonized water.

30. The dispensing assembly of claim 28, wherein the grit solutions comprises about 0.32% acrylic polymer.

31. The dispensing assembly of claim 28, wherein the grit solution comprises about 0.1% am inomethyl propanol.

32. The dispensing assembly of claim 28, wherein the grit solution comprises about 10% polyethylene grit.

33. The dispensing assembly of claim 32, wherein the grit solution comprises between about 5% and about 10% polyethylene grit.

34. The dispensing assembly of claim 25, wherein the soap is foamed and hides the grit solution within it as both flow through the exit port and are deposited on a user's hand.
